(19) United States
(12) Patent Application Publication
(10) Pub. No.: US 2026/0334360 A1
(43) Pub. Date: Oct. 29, 2026

(54) WEIGHT TRANSFER SYSTEM

(71) Applicant: Textron Inc., Providence, RI (US)

(72) Inventors: William Christopher Dickson, Stowmarket (GB); Chris Clifford, Ipswich (GB); Lee Aleksander Kristensen, Norwich (GB)

(73) Assignee: Textron Inc., Providence, RI (US)

(21) Appl. No.: 19/190,013

(22) Filed: Apr. 25, 2025

(51) Int. Cl. A01D 34/86; A01D 34/00; A01D 69/02; A01D 101/00

(52) U.S. Cl. CPC A01D 34/86; A01D 34/008; A01D 69/02; A01D 2101/00

(57) ABSTRACT

A mower includes a chassis, a tractive element coupled to the chassis, a mower deck, a weight transfer system coupled between the mower deck and the chassis, a sensor configured to facilitate acquiring a mower parameter, and a control system. When operating the mower in a mode, the control system is configured to acquire the mower parameter, the mower parameter including at least one of (a) a slope of the mower or (b) a location of the mower configured to indicate the slope of the mower, generate a countermeasure based on a comparison of the mower parameter to a threshold, the countermeasure including activating the weight transfer system to transfer at least a portion of a weight of the mower to the tractive element, and provide a signal to the weight transfer system to implement the countermeasure when the slope of the mower is greater than the threshold.

### BACKGROUND

Vehicles, such as mowers, may experience reduced traction and stability, particularly on steep slopes and uneven terrain. Reduced traction may lead to slipping and inefficient mowing operations. Strategies such as implementing a weight transfer system may enhance traction by redistributing the weight of the mower deck. This weight transfer reduces slippage and enables the mower to operate in challenging terrain.

### SUMMARY

One embodiment relates to a mower, including a chassis, a tractive element coupled to the chassis, a mower deck, a weight transfer system coupled between the mower deck and the chassis, a sensor configured to facilitate acquiring a mower parameter, and a control system. When operating the mower in a mode the control system is configured to acquire the mower parameter and generate a countermeasure based on a comparison of the mower parameter to a threshold. The mower parameter includes at least one of (a) a slope of the mower or (b) a location of the mower configured to indicate the slope of the mower. The countermeasure includes activating the weight transfer system to transfer at least a portion of a weight of the mower to the tractive element. The control system is configured to provide a signal to the weight transfer system to implement the countermeasure when the slope of the mower is greater than the threshold.

Another embodiment relates to a mower including one or more front wheels, one or more rear wheels, a hydraulic lift system including one or more lift cylinders, and a control system. Only one of (a) the one or more front wheels or (b) the one or more rear wheels are driven by the electric motor. The one or more lift cylinders are coupled to the mower deck. The control system is configured to acquire a mower parameter and generate a countermeasure based on a comparison of the mower parameter to a threshold. The mower parameter includes at least one of (a) a slope of the mower or (b) a location of the mower configured to indicate the slope of the mower. The countermeasure includes activating the hydraulic lift system to provide hydraulic back pressure to the lift cylinders to transfer a percentage of a mass of the mower onto one of (a) the one or more front wheels or (b) the one or more rear wheels driven by the electric motor. The control system is configured to provide a signal to the hydraulic lift system to implement the countermeasure when the mower parameter is greater than the threshold.

Still another embodiment relates to a mower including a chassis, a tractive element coupled to the chassis, a mower deck including one or more cutting elements, a mower arm coupled between the mower deck and the chassis, a weight transfer system coupled between the mower deck and the chassis, a sensor configured to facilitate acquiring a mower parameter, and a control system. When operating the mower in a mode, the control system is configured to: acquire the mower parameter, generate a countermeasure based on a comparison of the mower parameter to a first threshold, and determine if the mower arm is raised. The mower parameter includes at least one of (a) a slope of the mower or (b) a location of the mower configured to indicate the slope of the mower. The countermeasure includes activating the weight transfer system to transfer at least a portion of a weight of the mower to the tractive element. The control system is configured to provide a signal to the weight transfer system to implement the countermeasure when the slope of the mower is greater than the threshold, prevent the weight transfer system from implementing the countermeasure if the mower arm is raised, and prevent the one or more cutting elements from actuating when the slope is greater than a second threshold greater than the first threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, including an operator interface, a weight transfer system, and sensors, according to an exemplary embodiment.

FIG. 1B is a perspective view of a vehicle, according to another exemplary embodiment.

FIG. 2 is a schematic block diagram of the vehicle of FIG. 1A, according to an exemplary embodiment.

FIG. 3 is schematic block diagram of a site monitoring and control system including a plurality of the vehicles of FIG. 1A and a user portal, according to an exemplary embodiment.

FIG. 4 is a schematic diagram of the weight transfer system of the vehicle of FIG. 1A, according to an exemplary embodiment.

FIG. 5 is a block diagram of the sensors of the vehicle of FIG. 1A, according to an exemplary embodiment.

FIG. 6 is a perspective view of the operator interface of the vehicle of FIG. 1A, according to an exemplary embodiment.

FIG. 7 is a side view of the vehicle of FIG. 1A in a transport mode, according to an exemplary embodiment.

FIG. 8 is a side view of the vehicle of FIG. 1A in a cutting mode, according to an exemplary embodiment.

FIG. 9 is the user portal of FIG. 3, according to an exemplary embodiment.

FIG. 10 is the user portal of FIG. 3, according to an exemplary embodiment.

FIG. 11 is the user portal of FIG. 3, according to an exemplary embodiment.

FIG. 12 is the user portal of FIG. 3, according to an exemplary embodiment.

FIG. 13 is a flow diagram of a method for generating and implementing a weight transfer, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

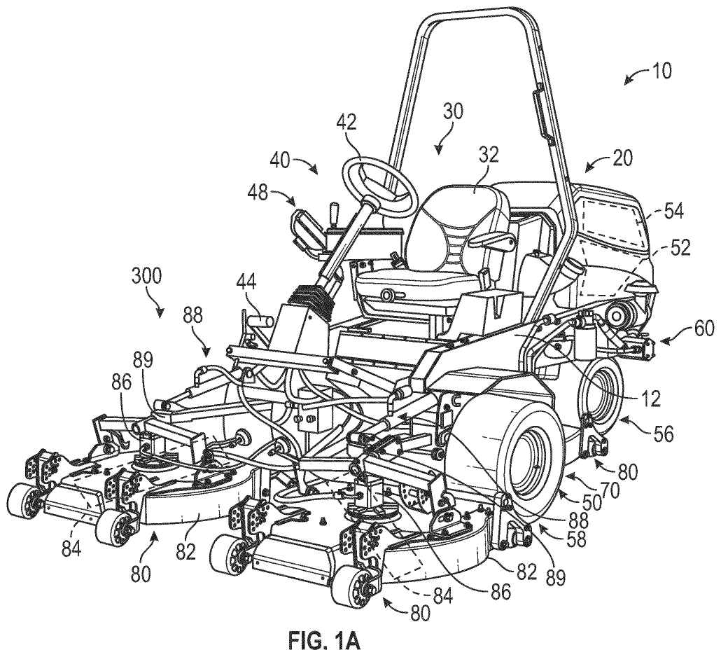

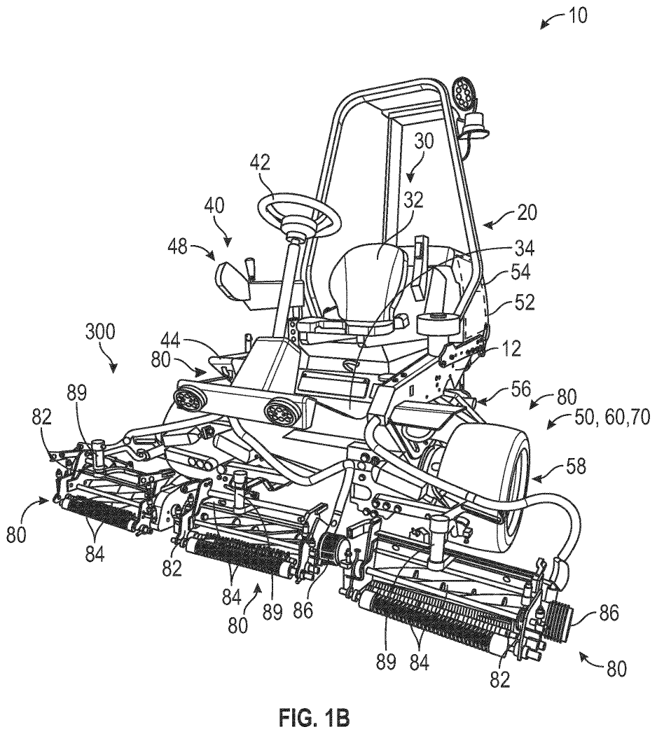

As shown in FIG. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

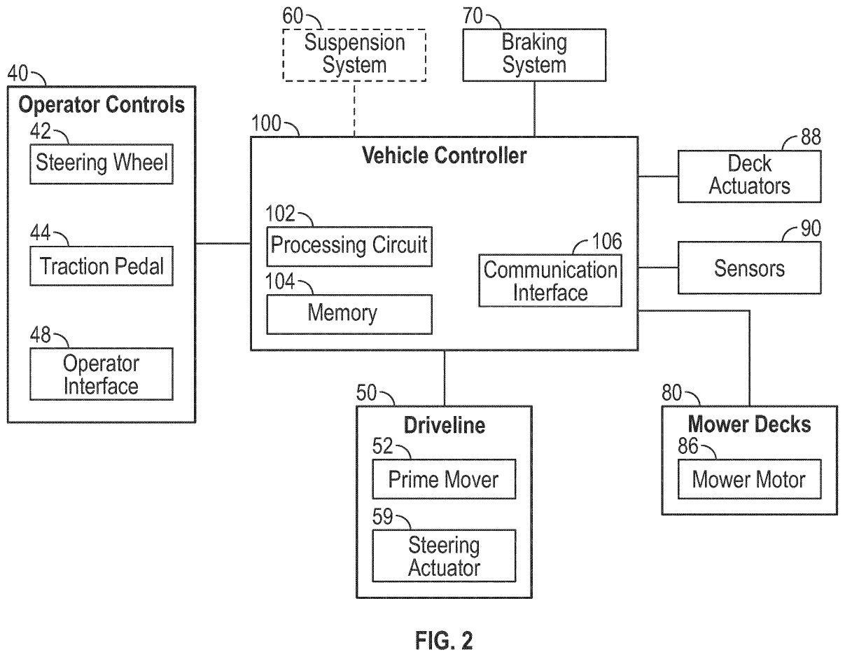

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A, 1B, and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A, 1B, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

As shown in FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the vehicle 10 of FIG. 1A may be substantially similar to the vehicle 10 of FIG. 1B. Accordingly, a description of the vehicle 10 of FIG. 1A may apply to the vehicle 10 of FIG. 1B, except as otherwise specified.

As shown in FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The vehicle 10 also includes a series of arms, shown as mower arms 89, each coupled between the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 represents a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other of the vehicles 10, the user sensors 220, the user portal 230, the remote systems 240, etc.). By way of example, the communication interface 106 may be configured to employ one or more types of wireless communications protocols including Bluetooth, Wi-Fi, radio, cellular, and/or other suitable wireless communications protocols.

### Site Monitoring and Control System

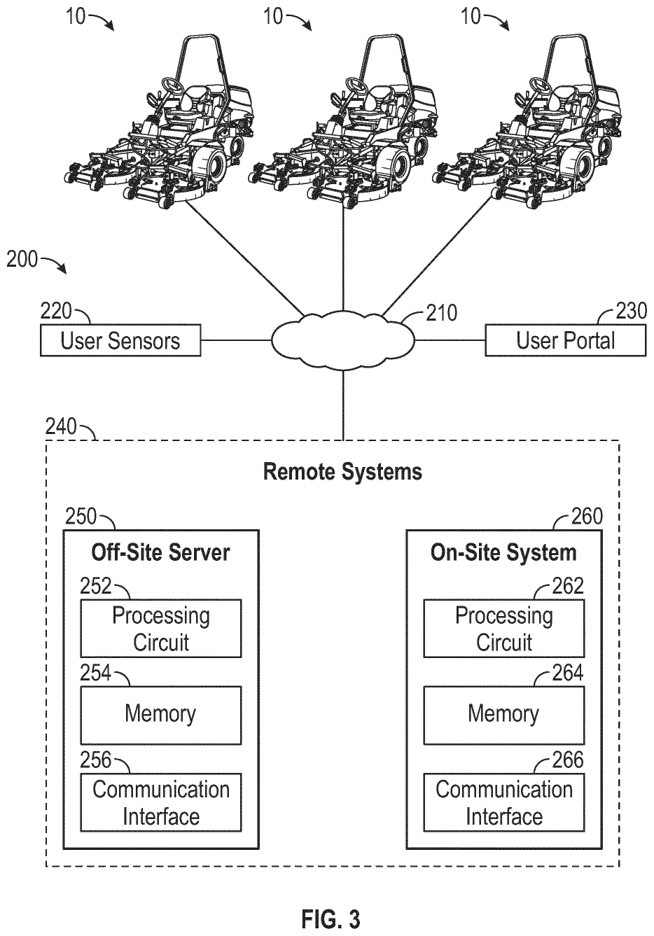

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

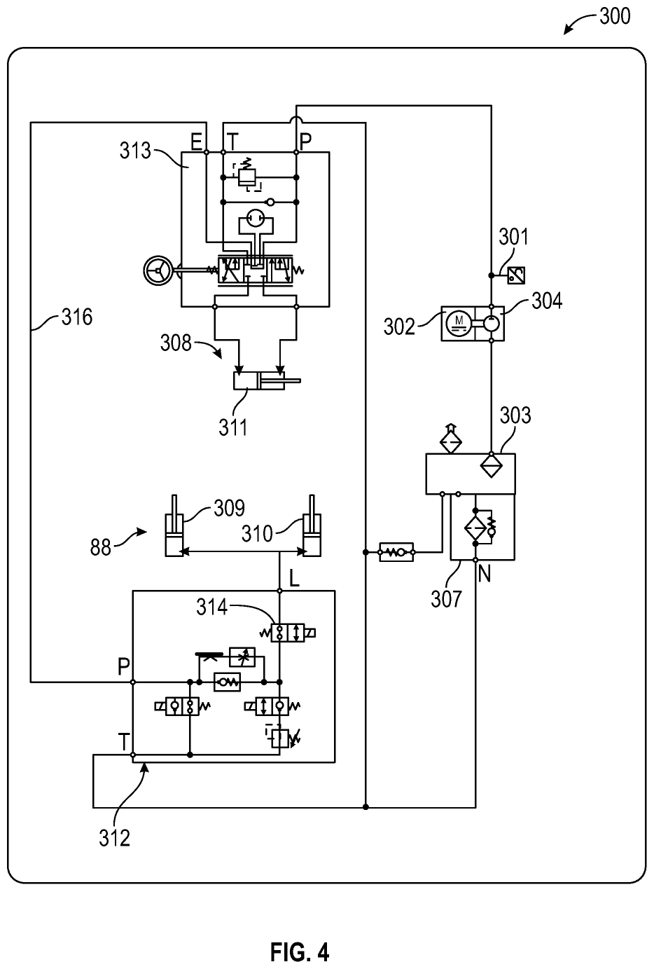

As shown in FIGS. 1A, 1B, 4, and 5, the vehicle 10 includes a load redistribution system, shown as weight transfer system 300. The vehicle 10 of FIGS. 1A and 1B may include the weight transfer system 300 positioned between the mower deck 80 and the chassis 12. When the vehicle 10 is a two-wheel drive vehicle 10, the weight transfer system 300 is used frequently while mowing, especially when mowing on gradients, or hills. The weight transfer system 300 includes a pressure sensor, shown as pressure transducer 301; a motor, shown as motor 302; a tank, shown as reservoir 303; a pump, shown as hydraulic pump 304; a filter, shown as return filter 307; a series of cylinders, shown as cylinders 308; one or more first valves, shown as control valves 312; a second valve, shown as steering valve 313; a third valve, shown as lift valve 314; and conduits, shown as hydraulic line 316. The cylinders 308 include the deck actuators 88 and a first cylinder, shown as steering cylinder 311. The deck actuators 88 include a second cylinder, shown as first lift cylinder 309; and a third cylinder, shown as second lift cylinder 310.

The pressure transducer 301 is configured to measure pressure of hydraulic fluid within the weight transfer system 300, and provide feedback to control system (e.g., site monitoring and control system 200, the vehicle controller 100, and/or the remote systems 240). The motor 302 provides power to the hydraulic pump 304 by converting electrical energy into mechanical energy. The hydraulic pump 304 is configured to move the hydraulic fluid from the reservoir 303 into the system (e.g., into and through the hydraulic line 316, etc.). The reservoir 303 is configured to store the hydraulic fluid and dissipate heat from the hydraulic fluid. The return filter 307 is configured to filter the hydraulic fluid as the hydraulic fluid returns to the reservoir 303, removing contaminants (e.g., dirt, debris, metal particles, etc.) from the hydraulic fluid to maintain system efficiency and prevent damage to components of the weight transfer system 300. Clean hydraulic fluid reduces friction and wear on components of the weight transfer system 300, reducing operating costs of the weight transfer system 300.

The control valves 312 are configured to regulate the flow of the hydraulic fluid to control the direction, pressure, and flow rate of the hydraulic fluid. The lift valve 314 is configured to manage the flow of hydraulic fluid to and from the first lift cylinder 309 and the second lift cylinder 310. When the lift valve 314 is activated, the lift valve 314 directs pressurized hydraulic fluid into the first lift cylinder 309 and the second lift cylinder 310, causing the first lift cylinder 309 and the second lift cylinder 310 to extend. When the lift valve 314 is deactivated, the hydraulic fluid is released form the first lift cylinder 309 and the second lift cylinder 310, enabling the first lift cylinder 309 and the vehicle 10 to retract and lower. The first lift cylinder 309 and the second lift cylinder 310 are each configured to extend and retract to lower and raise the mower deck 80. As the first lift cylinder 309 and the second lift cylinder 310 retract, the mower deck 80 weight is transferred to the tractive assembly driven by the prime mover 52. As the first lift cylinder 309 and the second lift cylinder 310 extend, the mower deck 80 weight is transferred off of the tractive assembly driven by the prime mover 52 and to the ground. The steering valve 313 directs hydraulic fluid from the hydraulic line 316 into steering cylinder 311. The steering cylinder 311 is configured to convert hydraulic energy to mechanical energy to steer the vehicle 10. The steering cylinder 311 extends and retracts, enabling the rear tractive assembly 56 and the front tractive assembly 58 to turn steer the vehicle 10.

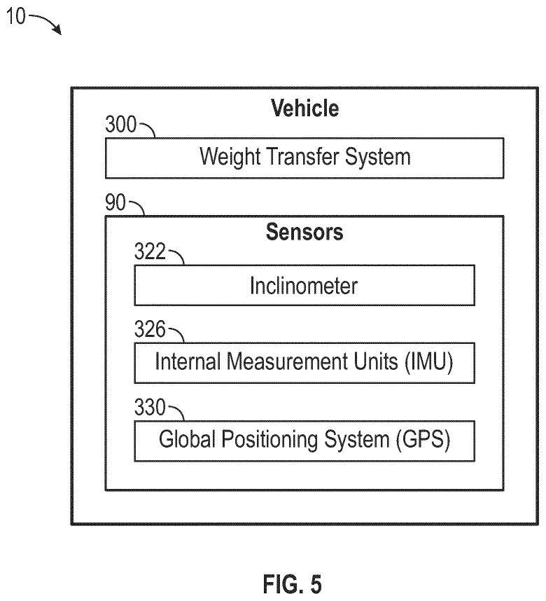

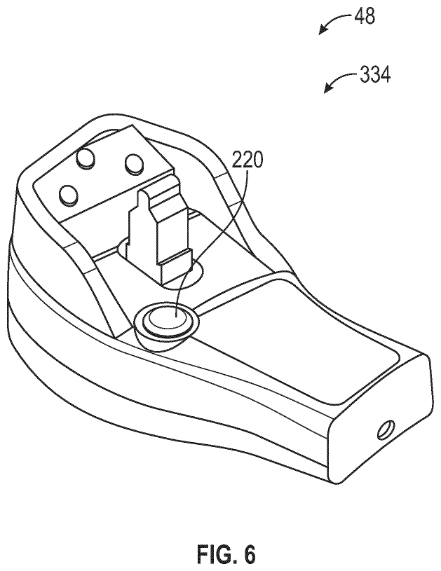

As shown in FIG. 5, the sensors 90 include an inclinometer 322, IMUs 32, and a GPS 330. The sensors 90 are configured to acquire one or more mower parameters. The inclinometer 322 and the IMUs 326 are configured to detect a slope (e.g., incline, angle, etc.) of the vehicle 10. The inclinometer 322 and the IMUs 326 may detect a first slope of the vehicle 10 along a first axis and a second slope of the vehicle 10 along a second axis. For example, the first slope may be a slope of the vehicle 10 along a first, X-axis (e.g., longitudinal axis) with respect to a center of the vehicle 10, and the second slope may be a slope of the vehicle 10 along a second, Y-axis (e.g., lateral axis) with respect to the center of the vehicle 10. The GPS 330 is configured to facilitate detecting or tracking a location of the vehicle 10. The location of the vehicle 10 may facilitate determining the first slope of the vehicle 10 along the first axis and the second slope of the vehicle 10 along the second axis.

As shown in FIG. 6, the operator interface 48 includes an armrest 334. The armrest 334 includes the user sensor 220. The user sensor 220 may be engaged by a user to activate the weight transfer system 300. In the illustrated embodiment, the user sensor 220 is a button. In some embodiments, the user sensor 220 is a switch. In some embodiments, the user activates the weight transfer system 300 by continuously pressing the user sensor 220 (e.g., when the user sensor 220 detects a continuous input). In some embodiments, the user activates the weight transfer system 300 by pressing the user sensor 220 once, and turns off the weight transfer system 300 by pressing the user sensor 220 a second time (e.g., the weight transfer system 300 is activated when the user sensor 220 senses a first input and the the weight transfer system 300 is deactivated when the user sensor 220 senses a second input). In some embodiments, the user activates the weight transfer system 300 by pressing the user sensor 220 once and deactivates the weight transfer system 300 by pressing the user sensors 220 a second time (e.g., the weight transfer system 300 is activated when the user sensor 220 senses a first input and the weight transfer system 300 is deactivated when the user sensor 220 senses a second input).

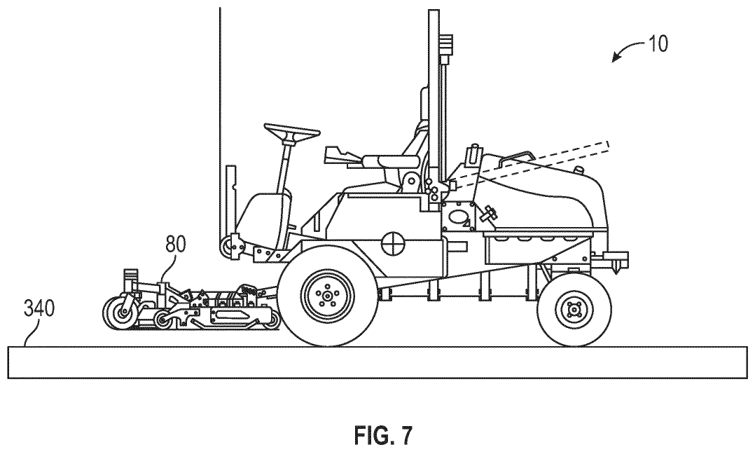

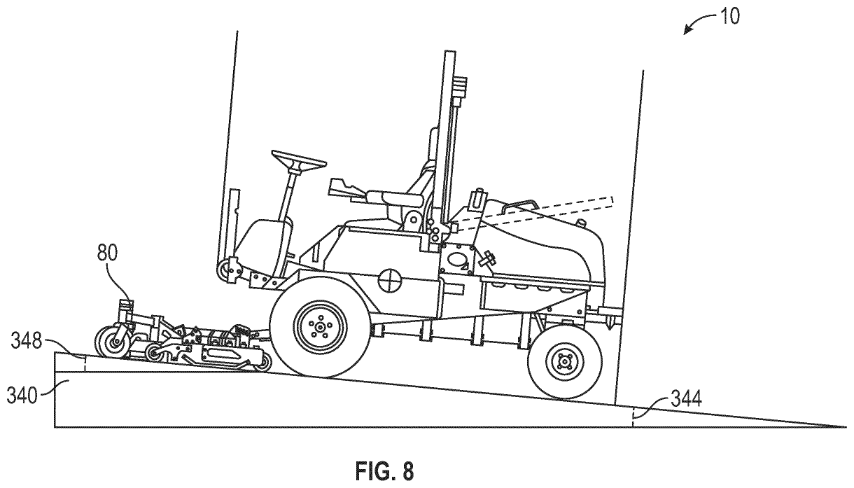

As shown in FIG. 7, when the vehicle 10 is in a transport mode, the mower deck 80 and the mower arm 89 are spaced from, or lifted from, a ground surface 340 the vehicle 10 is traversing. In the transport mode, the mass of the mower deck 80 is supported by the front tractive assembly 58. As shown in FIG. 8, the mower deck 80 contacts the ground surface 340 when the vehicle 10 is in a cutting mode and the mower arm 89 is lowered. In the cutting mode, the cutting element 84 are configured to actuate. In the cutting mode, the mass of the mower deck 80 is no longer supported by the front tractive assembly 58, and is instead supported by the ground surface 340, reducing the amount of torque the rear tractive assembly 56 and/or the front tractive assembly 58 can transmit before slipping (e.g., the amount of torque the driving tractive element can transmit before slipping is reduced). In some embodiments, when the vehicle 10 is front-wheel drive, the amount of torque the front tractive assembly 58 can transmit before slipping is reduced. In some embodiments, when the vehicle 10 is a rear-wheel drive, the amount of torque the rear tractive assembly 56 can transmit before slipping is reduced. In some embodiments, when the vehicle 10 is an all-wheel drive vehicle 10, the amount of torque the rear tractive assembly 56 and the front tractive assembly 58 can transmit before slipping is reduced. In the cutting mode, tractive effort from the driving rear tractive assembly 56 and/or front tractive assembly 58 is also increased due to increased resistance from pushing the mower deck 80 along the ground surface 340 and through the grass.

As shown in FIG. 8, the vehicle 10 traverses a first incline, shown as ground slope 344, along a second incline, shown as mower slope 348. The ground slope 344 is the slope of the location the vehicle 10 traverses. The mower slope 348 is the slope of the vehicle 10. The GPS 330 facilitates determining (e.g., by the site monitoring and control system 200, the vehicle controller 100, and/or the remote systems 240) the location of the vehicle 10 and corresponding the location of the vehicle 10 to a corresponding ground slope 344. The inclinometer 322 and/or the IMUs 326 are configured to sense the mower slope 348 directly. The control system may acquire a topography map to compare the location of the vehicle 10 to the map, determine the ground slope 344 from the location on the map, and correlate the ground slope 344 to the mower slope 348. In the illustrated embodiment, the ground slope 344 and the mower slope 348 are along the first axis. In some embodiments, mower slope 348 includes a first slope along the first axis and a second slope along the second axis. In some embodiments, the ground slope 344 includes a first slope along the first axis and a second slope along the second axis.

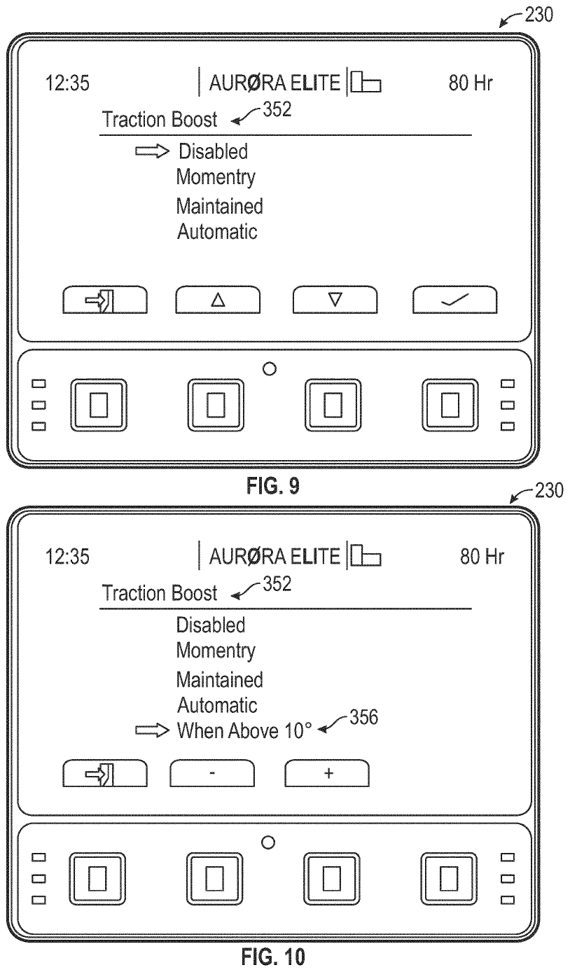

As shown in FIG. 9-12, the user portal 230 provides a traction boost setting, shown as traction boost interface 352. The traction boost interface 352 provides an indication of multiple modes. The modes include a first mode, shown as disabled; a second mode, shown as momentary; a third mode, shown as maintained; and a fourth mode, shown as automatic. The user portal 230 enables a user to choose one or more of the modes. In the first mode, the weight transfer system 300 is disabled. In the second mode, the weight transfer system 300 is turned on while the user sensors 220 continuously senses an input. In the third mode, the weight transfer system 300 is turned on when the user sensors 220 senses a first input, and the weight transfer system 300 is turned off by when the user sensors 220 senses a second input. In the fourth mode, the weight transfer system 300 is configured to turn on and off and adjust automatically in accordance with the control system. During the fourth mode, the weight transfer system 300 may also be manually activated, similar to in the third mode. The fourth mode enables the weight transfer system 300 to automatically adjust and turn on and off, while enabling the user to turn the weight transfer system 300 on temporarily. For example, the user may anticipate difficult terrain is approaching, and manually turn on the weight transfer system 300 before contacting the difficult terrain. In some embodiments, the fourth mode enables the user to manually override the weight transfer system 300 only when the mower slope 348 is below a threshold (e.g., when the mower slope 348 is below 10 degrees the user may manually turn on the weight transfer system 300).

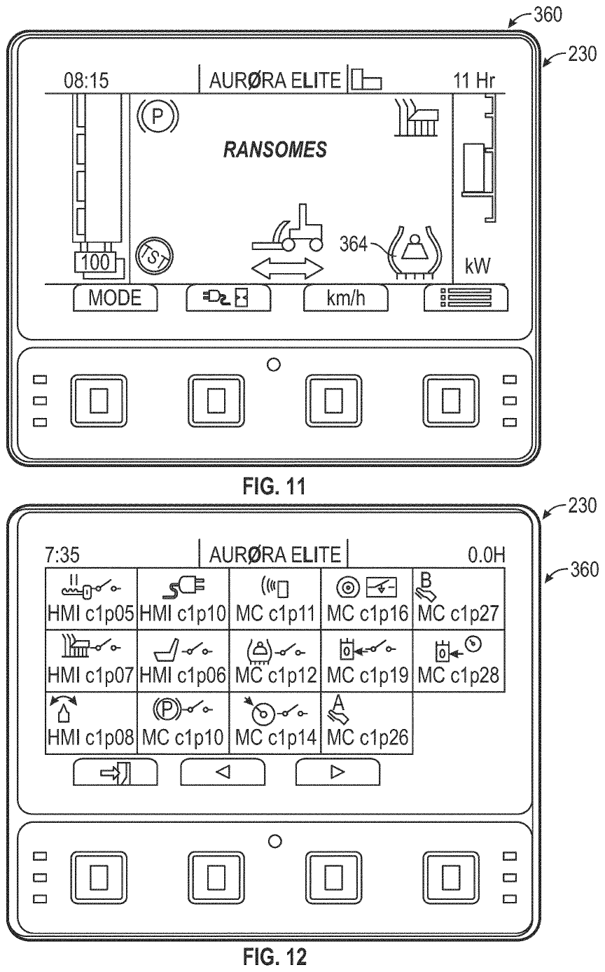

The traction boost interface 352 includes a slope setting, shown as threshold section 356, as shown in FIG. 10. The threshold section 356 enables a user to customize the threshold of the weight transfer system 300 during the fourth setting. In the illustrated embodiment, the threshold is 10 degrees, and the weight transfer system 300 is automatically turned on when the ground slope 344 or the mower slope 348 is above 10 degrees and the weight transfer system 300 is in the fourth mode. In some embodiments, the threshold section 356 enables a user to select multiple thresholds. For example, the thresholds may include a first slope threshold, a second slope threshold, and a speed threshold. As shown in FIGS. 11 and 12, the user portal 230 is configured to display a mower status 360. The mower status 360 includes information such as battery life of the vehicle 10 and an indication of the traction boost, shown as traction boost status 364. When the traction boost status 364 is displayed, the weight transfer system 300 is activated.

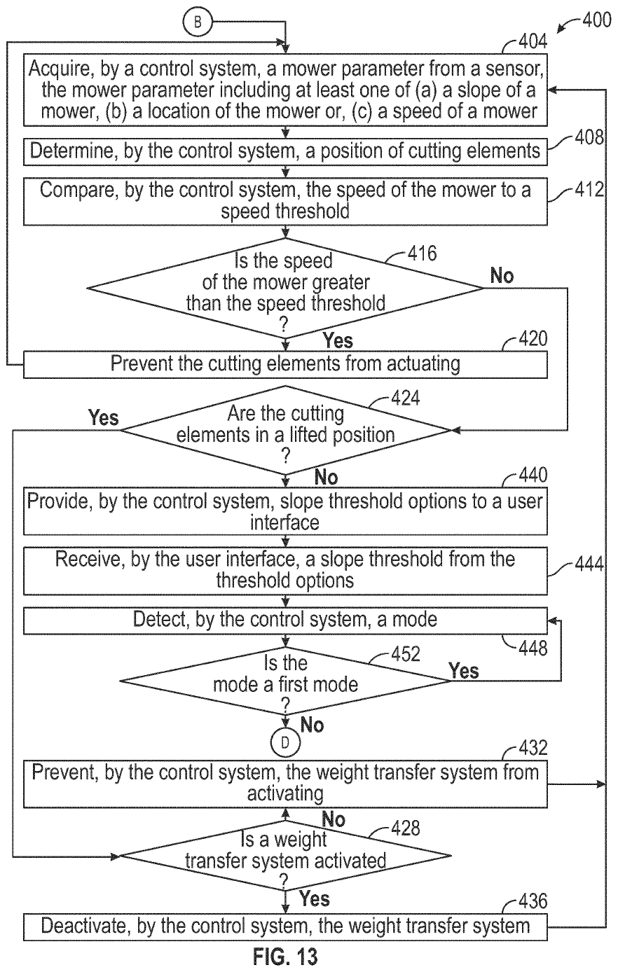

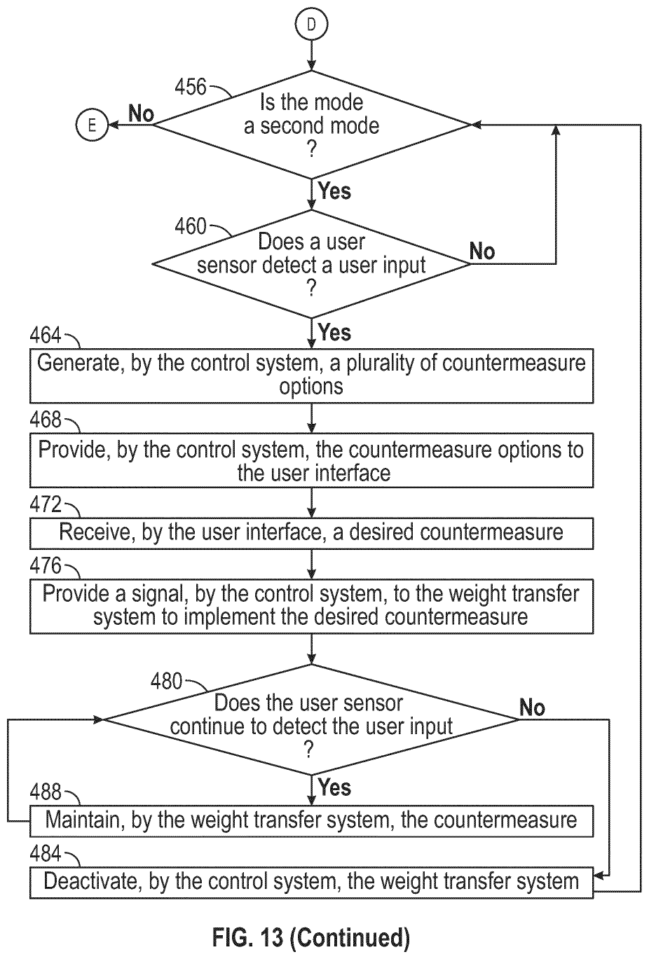

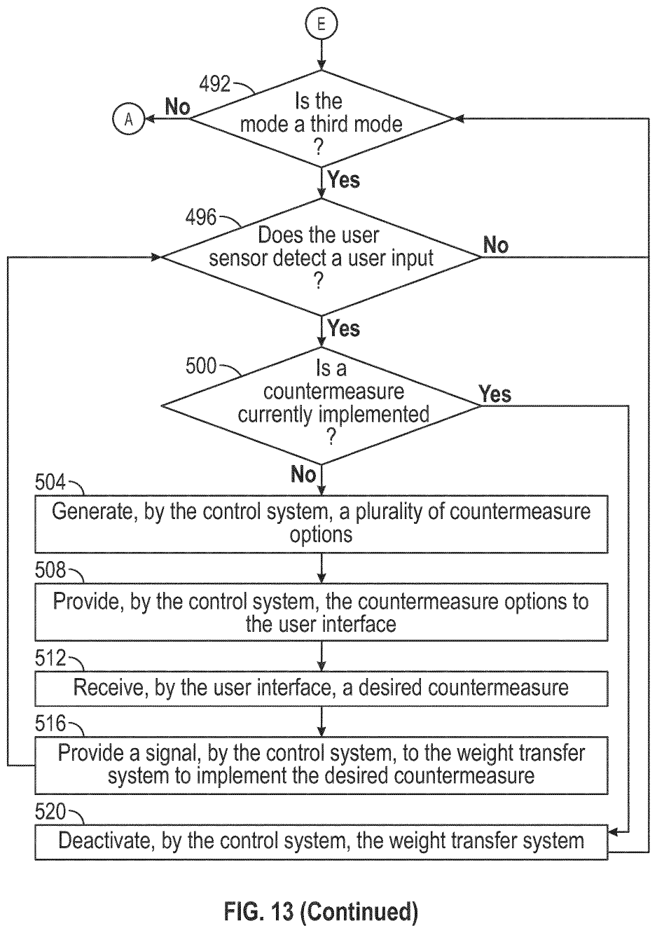

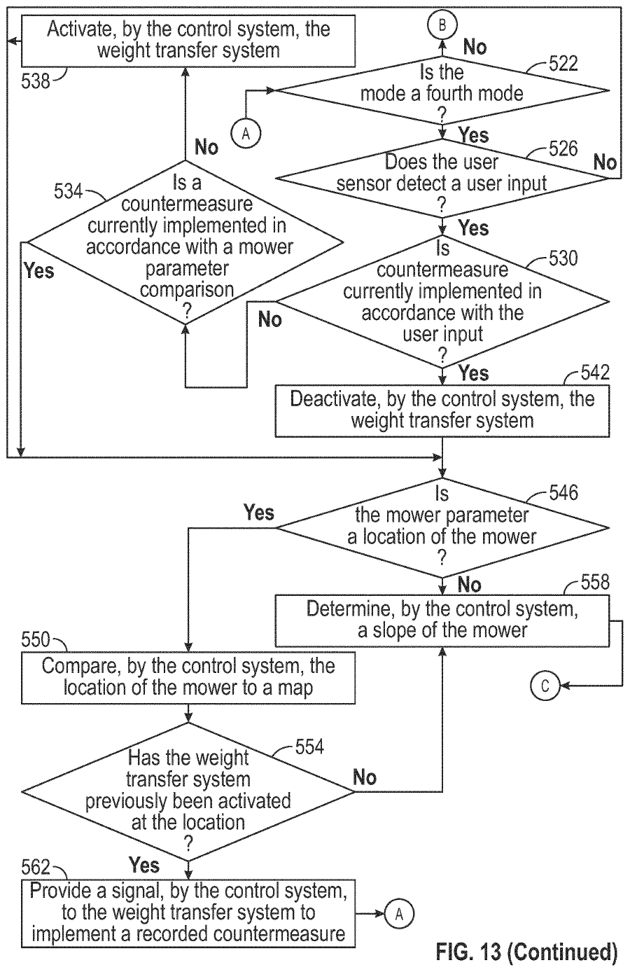

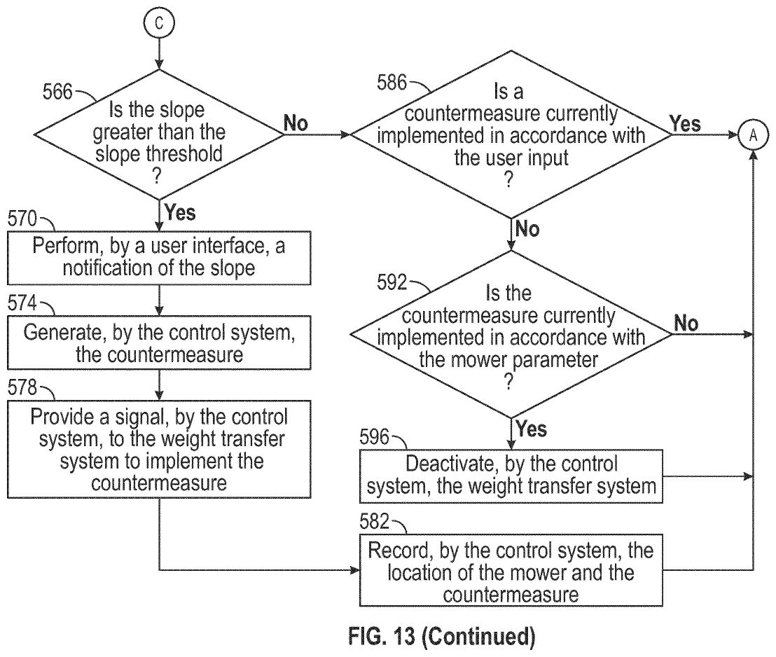

As shown in FIG. 13, a method 400 for generating and implementing weight transfer is provided. The method 400 may be performed by the site monitoring and control system 200, the vehicle controller 100, and/or the remote systems 240.

At step 404, a control system (e.g., the site monitoring and control system 200, the vehicle controller 100, the remote systems 240, etc.) is configured to acquire (e.g., detect, record, collect, determine, etc.) a mower parameter including at least one of (a) the mower slope 348, (b) a location of the vehicle 10, or (c) a speed of the vehicle 10. As stated previously, the location of the vehicle 10 may be used to correlate to the ground slope 344, and therefore the mower slope 348. The speed of the vehicle 10 may be determined from a speed of the rear tractive assembly 56, a speed of the front tractive assembly 58, or a speed of the mower motor 86. In some embodiments, the mower slope 348 includes at least one of a first slope of the vehicle 10 along the first axis or a second slope of the vehicle 10 along the second axis.

At step 408, the control system is configured to determine a position of the cutting element 84. The position of the cutting element 84 is a distance from the cutting element 84 to the ground surface 340. When the cutting element 84 is in a lifted position, the vehicle 10 is in the transport mode, and the cutting element 84 is configured to be stationary with respect to the mower deck 80. In some embodiments, determining a position of the cutting element 84 may include determining if the mower arm 89 is raised. If the mower arm 89 is raised, the vehicle 10 is in transport mode.

At step 412, the control system is configured to compare the speed of the vehicle 10 to a speed threshold. At step 416, the control system is configured to determine if the speed of the vehicle 10 is greater than a speed threshold. If the control system determines the speed of the vehicle 10 is greater than the speed threshold, the control system is configured to proceed to step 420. At step 420, the control system is configured to prevent the cutting element 84 from actuating. That is, if the vehicle 10 is traveling at high speeds, the control system prevents the vehicle 10 from mowing. The control system then proceeds back to step 404. If at step 412 the control system determines the vehicle 10 speed is not less than the speed threshold, the control system is configured to proceed to step 424.

At step 424, the control system is configured to determine if the cutting element 84 is in a lifted position. If the position acquired in step 408 indicates the cutting element 84 is in the lifted position, the control system is configured to proceed to step 428. At step 428, the control system is configured to determine if the weight transfer system 300 is activated. If the weight transfer system 300 is activated, the control system is configured to proceed from step 428 to step 436. At step 436, the control system is configured to deactivate the weight transfer system 300 and proceed to step 404. If at step 428 the control system determines the weight transfer system 300 is not activated, the control system is configured to proceed to step 432. At step 432, the control system is configured to prevent the weight transfer system 300 from activating. The control system then proceeds to step 404. That is, if the mower arm 89 or the cutting element 84 is lifted and the vehicle 10 is in the transport mode, the weight transfer system 300 is deactivated or prevented from being activated.

If the control system determines the cutting element 84 is not lifted at step 424, the control system is configured to proceed to step 440. At step 440, the control system is configured to provide slope threshold options to the user portal 230. The slope threshold options indicate the maximum desired slope the vehicle 10 may traverse before the weight transfer system 300 is activated. At step 444, the control system is configured to receive, by the user portal 230, the threshold section 356 from the slope threshold options. The threshold section 356 indicates the slope threshold. In some embodiments, the slope thresholds are preset by the manufacture or previously set by the operator such that step 440 and step 444 are omitted. At step 448, the control system is configured to detect a mode. The mode is the first mode, the second mode, the third mode, or the fourth mode.

At step 452, the control system is configured to determine if the mode is the first mode. If the mode is a first mode, the control system is configured to proceed to step 448. As described previously, in the first mode the weight transfer system 300 is disabled. If the control system is not a first mode, the control system is configured to proceed to step 456.

At step 456, the control system is configured to determine if the mode is a second mode. During the second mode, the weight transfer system 300 is activated when the user sensors 220 continuously senses an input. If the control system determines the mode is the second mode, the control system is configured to proceed to step 460. At step 460, the control system is configured to determine if the user sensor 220 detects an input to the user sensor 220. If the input is not detected, the control system is configured to proceed back to step 456 and continue to monitor for an input or to a change in the mode. If the user input is detected, the control system is configured to proceed to step 464. At step 464, the control system is configured to generate a plurality of countermeasure options. The countermeasure options include levels of hydraulic back pressure provided to the first lift cylinder 309 and/or the second lift cylinder 310 to transfer percentages of a mass of the mower deck 80 onto the front tractive assembly 58 and/or the rear tractive assembly 56 without lifting the mower deck 80. In some embodiments, when there is a first slope and a second slope of the vehicle 10, generating the countermeasure includes at least one of comparing the first slope of the vehicle 10 to the first slope threshold or comparing the second slope of the vehicle 10 to the second slope threshold. In some embodiments, the countermeasure is preset in the second and third modes.

At step 468, the control system is configured to provide the countermeasure options to the user portal 230. At step 472 the user portal 230 is configured to receive a desired countermeasure. The desired countermeasure is an indication from the user of which countermeasure to implement. At step 476 the control system is configured to provide a signal to the weight transfer system 300 to implement the desired countermeasure. Implementing the desired countermeasure includes adjusting the levels of the hydraulic back pressure provided to the first lift cylinder 309 and/or the second lift cylinder 310.

At step 480, the control system is configured to determine if the user sensor 220 continues to detect the user input. If at step 480 the control system determines the user sensors 220 continues to detect the user input, the control system is configured to proceed to step 488. At step 488 the weight transfer system 300 is configured to maintain the countermeasure and the control system is configured to proceed to step 480. If at step 480 the control system does not determine the user sensor 220 detects the user input, the control system is configured to proceed to step 484. At step 484, the control system is configured to deactivate the weight transfer system 300 and the control system is configured to proceed to step 456 to monitor a change in the mode. That is, the weight transfer system 300 is activated only while the user sensors 220 continuously senses an input.

If at step 456 the control system determines the mode is not the second mode, the control system is configured to proceed to step 492. At step 492 the control system is configured to determine if the mode is third mode. During the third mode, the weight transfer system 300 is activated after the user sensor 220 detects a first input and is deactivated after the user sensor 220 senses a second input. If at step 492 the control system determines that the mode is third mode, the control system is configured to proceed to step 496. At step 496, the control system is configured to determine if the user sensor 220 detects a user input. If at step 496 the control system determines the user sensor 220 does not detect the user input, the control system is configured to proceed back to step 492.

If at step 496 the control system determines that the user sensor 220 does detect a user input, the control system is configured to proceed to step 500. At step 500, the control system is configured to determine if the countermeasure is currently implemented. If the countermeasure is not currently implemented the control system is configured to proceed to step 504. At step 504, the control system is configured to generate a plurality of countermeasure options. The countermeasure options include levels of hydraulic back pressure provided to the first lift cylinder 309 and/or the second lift cylinder 310 to transfer percentages of a mass of the mower deck 80 onto the front tractive assembly 58 and/or the rear tractive assembly 56without lifting the mower deck 80. At step 508, the controls system is configured to provide the countermeasure options to the user portal 230. At step 512 the user portal 230 is configured to receive the desired countermeasure. At step 516, the control system is configured to provide a signal to the weight transfer system 300 to implement the desired countermeasure and the control system is configured to proceed to step 496.

If at step 500 the control system determines the countermeasure is currently implemented, the control system is configured to proceed to step 520. At step 520 the control system is configured to deactivate the weight transfer system 300 and the control system is configured to proceed to step 492. That is, if the user sensor 220 has already sensed a first input, when the user sensor 220 senses a second input, the weight transfer system 300 turns off.

If at step 492, the control system determines the mode is not a third mode, the control system is configured to proceed to step 522. At step 522, the control system is configured to determine if the mode is fourth mode. The fourth mode is the automatic mode. If the control system determines the mode is not the fourth mode, the control system is configured to proceed to step 404. If the control system determines the mode is the fourth mode, the control system is configured to proceed to step 526. At step 526, the control system is configured to determine if the user sensor 220 detects the user input. If at step 526 the control system determines the user sensor 220 does detect a user input, the control system is configured to proceed to step 530. At step 530, the control system is configured to determine if the countermeasure is currently implemented in accordance with the user input. If at step 530 the control system determines the counter measure is not currently implemented in accordance with the user input, the control system is configured to proceed to step 534. At step 534, the control system is configured to determine if the countermeasure is currently implemented in accordance with a mower parameter comparison. If at step 534, the controller determines the countermeasure is not currently implemented in accordance with the mower parameter comparison, the control system is configured to proceed to step 538. At step 538, the control system is configured to activate the weight transfer system 300 and the control system is configured to proceed to step 546.

If at step 534 the control system determines the countermeasure is currently implemented in accordance with the mower parameter comparison, the control system proceeds to step 546. If at step 530 the control system determines the countermeasure is currently implemented in accordance with the user input, the control system is configured to proceed to step 542. At step 542, the control system is configured to deactivate the weight transfer system 300 and control system is configured to proceed to step 546. This loop of steps 526-542 enables the user to manually control the weight transfer system 300, similar to the second mode. As stated previously, this loop may be enabled only for slopes below a threshold (e.g., steps 526-542 may be enabled when the mower slope 348 is less than 10 degrees and when the mower slope 348 is greater than 10 degrees steps 526-542 are omitted). In some embodiments, when the fourth mode only includes automatically adjusting the weight transfer system 300, steps 526-542 are omitted.

At step 546, the control system is configured to determine if the mower parameter is a location of the vehicle 10. If at step 546 the control system determines the mower parameter is the location of the vehicle 10, the control system is configured to proceed to step 550. At step 550 the control system is configured to compare the location of the vehicle 10 to a map acquired by the control system. At step 554, the control system is configured to determine if the weight transfer system 300 previously has been activated at the location. If at step 554, the control system determines the weigh transfer system has been previously activated at the location, the control system is configured to proceed to step 562. At step 562, the control system is configured to provide a signal to the weight transfer system 300 to implement a recorded countermeasure, and the control system is configured to proceed to step 522. The control system cross references previously recorded locations and their corresponding recorded countermeasures to automatically adjust the weight transfer system 300 to the recorded countermeasure. That is, control system determines if a location where the weight transfer system 300 was activated at a first point in time is the same as the location vehicle 10 at as second point in time after the first point in time. If the locations are the same, the control system is configured to activate the weight transfer system 300 at the second point in time.

If at step 554 the control system determines the weight transfer system 300 has not been previously activated at the location, the control system is configured to proceed to step 558. If at step 546, the control system determines the mower parameter is not a location of the vehicle 10, the control system is configured to proceed to step 558. At step 558, the control system is configured to determine the mower slope 348. If the mower parameter is not a location of the vehicle 10, the mower slope 348 is acquired using the inclinometer 322 and/or the IMU 326 to directly measure the mower slope 348. In some embodiments, the first slope of the vehicle 10 along the first axis and the second slope of the vehicle 10 along the second axis are both measured. If the mower parameter is the location of the vehicle 10, the mower slope 348 is generated by acquiring the map, comparing the location of the vehicle 10 to the map, determining the ground slope 344 of the location on the map, and correlating the ground slope 344 to the mower slope 348. The location of the vehicle 10 is acquired from the GPS 330. In some embodiments, the location of the vehicle 10 is configured to indicate at least one of the first slope of the vehicle 10 along the first axis or the second slope of the vehicle 10 along the second axis.

At step 566, the control system is configured to determine if the mower slope 348 is greater than a slope threshold. If at step 566 the control system determines the mower slope 348 is greater than the slope threshold, the control system is configured to proceed to step 570. In some embodiments, the mower slope 348 is compared to a first threshold and a second threshold. For example, if the mower slope 348 is greater than the first threshold, the control system is configured to proceed to step 570. The comparison of the mower slope 348 to the second threshold may be used later on in the method 400 when generating a countermeasure (e.g., to determine if the countermeasure will include preventing the cutting element 84 from actuating). In some embodiments, when there is a first mower slope 348 and a second mower slope 348, the first mower slope 348 is compared to a first slope threshold and the second mower slope 348 is compared to a second slope threshold. For example, if at least one of the first mower slope 348 is greater than the first slope threshold or the second mower slope 348 is greater than the second slope threshold, the control system is configured to proceed to step 570. In some embodiments, when there is a first mower slope 348 and a second mower slope 348, the first mower slope 348 is compared to both a first slope threshold and a third slope threshold and the mower slope 348 is compared to both a second slope threshold and a fourth slope threshold. For example, if at least one of the first mower slope 348 is greater than the first slope threshold and the second mower slope 348 is greater than the second slope threshold, the control system is configured to proceed to step 570. The comparison of the first mower slope 348 to the third slope threshold and the second mower slope 348 to the fourth slope threshold may be used later on in the method 400 when generating the countermeasure (e.g., to determine if the countermeasure will include preventing the cutting element 84 from actuating).

At step 570, the control system is configured to perform a notification of the mower slope 348 to the user portal 230. The user portal 230 alerts the user to the current mower slope 348 when the mower slope 348 is higher than the slope threshold. In some embodiments, the user portal 230 always displays the mower slope 348. In some embodiments, the user portal 230 display a warning symbol, such as the traction boost status 364, that the automatic weight transfer system 300 will be turned on due to mower slope 348 levels. At step 574, the control system is configured to generate the countermeasure. The countermeasure is generated based on a comparison of the mower parameter to the slope threshold. The countermeasure includes adjusting the hydraulic back pressure provided to the first lift cylinder 309 and/or the second lift cylinder 310 to transfer a percentage of a mass of the mower deck 80 onto the front tractive assembly 58 and/or the rear tractive assembly 56 without lifting the mower deck 80. The percentage of mass of the mower deck 80 that is transferred may be preset (e.g., 75% of the mass of the mower deck 80 may always be transferred) or set in accordance with the distance from the threshold. For example, the percentage of the mass of the mower deck 80 transferred may be greater when the mower slope 348 is farther from the slope threshold than when the mower slope 348 closer to the slope threshold (e.g., 20% of the mass of the mower deck 80 may be transferred when the mower slope 348 is 12 degrees and the slope threshold is 10 degrees and 50% of the mass of the mower deck 80 may be transferred when the mower slope 348 is 14 degrees and the slope threshold is 10 degrees.) In some embodiments, the countermeasure also includes preventing the cutting element 84 from actuating. For example, if the mower slope 348 is compared to a first threshold and a second threshold and the mower slope 348 is greater than the second threshold, the countermeasure includes preventing the cutting element 84 from actuating (e.g., if the mower slope 348 is greater than 24 degrees the cutting element 84 are prevented from actuating, etc.). In another example, if a first mower slope 348 is compared to a first threshold and a third threshold, and a second mower slope 348 is compared to a second threshold and a fourth threshold, if at least one of the third threshold is greater than the first mower slope 348 or the fourth threshold is greater than the second mower slope 348, the countermeasure includes preventing the cutting element 84 from actuating.

At step 578, the control system is configured to provide a signal to the weight transfer system 300 to implement the countermeasure. At step 582, the controls system is configured to record the location of the vehicle 10 and the countermeasure, and the control system is configured to proceed back to step 522. These recorded values may be used later during steps 546-562.

If at step 566 the control system determines the mower slope 348 is not greater than the slope threshold, the control system is configured to proceed to step 586. At step 586 the control system is configured to determine if a countermeasure is currently implemented in accordance with the user input. If at step 586 the control system determines the countermeasure is currently implemented in accordance with the user input, the control system is configured to proceed to step 522. That is, if the mower slope 348 is not greater than the slope threshold, the automatic weight transfer system 300 will not activate, but the manual system may still be in place. If at step 586 the control system determines the countermeasure is not currently implemented in accordance with the user input, the control system is configured to proceed to step 592. In some embodiments, when the fourth mode is automatic only, step 586 is omitted and step 566 proceeds directly to 522 instead (e.g., when the mower slope 348 is greater than 10 degrees the manual system is disabled and step 586 is omitted). At step 592 the control system is configured to determine if the countermeasure is currently implemented in accordance with the mower parameter. If at step 592 the control system determines the countermeasure is not currently implemented in accordance with the mower parameter, the control system is configured to proceed to step 522. If at step 592 the control system determines the countermeasure is currently implemented in accordance with the mower parameter, the control system is configured to proceed to step 596. At step 596, the control system is configured to deactivate the weight transfer system 300 and the control system is configured to proceed to step 522. That is, when the mower slope 348 is less than the slope threshold, if the automatic weight transfer system 300 is currently activated, the control system is configured to deactivate the weight transfer system 300.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower, comprising:
a chassis;
a tractive element coupled to the chassis;
a mower deck;
a weight transfer system coupled between the mower deck and the chassis;
a sensor configured to facilitate acquiring a mower parameter; and
a control system, when operating the mower in a mode, configured to:
acquire the mower parameter, the mower parameter including at least one of (a) a slope of the mower or (b) a location of the mower configured to indicate the slope of the mower;
generate a countermeasure based on a comparison of the mower parameter to a threshold, the countermeasure including activating the weight transfer system to transfer at least a portion of a weight of the mower to the tractive element; and
provide a signal to the weight transfer system to implement the countermeasure when the slope of the mower is greater than the threshold.

2. The mower of claim 1, wherein the weight transfer system is a hydraulic lift system, the hydraulic lift system includes one or more lift cylinders, and implementing the countermeasure includes providing hydraulic back pressure to the lift cylinders to transfer a percentage of a mass of the mower deck onto the tractive element without lifting the mower deck.

3. The mower of claim 1, wherein:
the slope of the mower includes least one of (a) a first slope of the mower along a first axis or (b) a second slope of the mower along a second axis; and
the location of the mower is configured to indicate at least one of (a) the first slope of the mower along the first axis or (b) the second slope of the mower along the second axis.

4. The mower of claim 3, wherein:
generating the countermeasure includes at least one of comparing (a) the first slope of the mower to a first threshold or (b) the second slope of the mower to a second threshold; and
the signal is provided to the weight transfer system when at least one of (a) the first slope is greater than the first threshold or (b) the second slope is greater than the second threshold.

5. The mower of claim 4, wherein:
the mower deck includes one or more cutting elements; and
wherein the control system is configured to:
compare at least one of (a) the first slope of the mower to a third threshold or (b) the second slope of the mower to a fourth threshold; and
prevent the cutting elements from actuating when at least one of (a) the first slope is greater than the third threshold or (b) the second slope is greater than the fourth threshold.

6. The mower of claim 1, wherein the sensor is at least one of an inclinometer sensor or an Internal Measurement Sensor (IMU), and the mower parameter is the slope of the mower.

7. The mower of claim 1, wherein the sensor is a global positioning system (GPS), the mower parameter is the location of the mower, and determining the slope of the mower includes:
acquiring a map;
comparing the location of the mower to the map;
determining the slope of a surface of the location on the map; and
correlating the slope of the surface to the slope of the mower.

8. The mower of claim 1, wherein the control system is configured to:
determine the location where the weight transfer system is activated at a first point in time;
store the location; and
activate the weight transfer system at the location at a second point in time after the first point in time.

9. The mower of claim 1, further comprising a user sensor, wherein the mode is a fourth mode, and wherein the control system is configured to switch between:
a first mode where the weight transfer system is disabled;
at least one of:
a second mode where the control system is configured to activate the weight transfer system while the user sensor senses a continuous input; or
a third mode where the control system is configured to:
activate the weight transfer system when the user sensor senses a first input, and
deactivate the weight transfer system when the user sensor senses a second input; and
the fourth mode.

10. The mower of claim 9, wherein, in the fourth mode, the control system is configured to activate the weight transfer system while the user sensor senses the continuous input.

11. The mower of claim 9, further comprising a user interface, wherein:
the control system is configured to:
provide a plurality of threshold options to the user interface; and
receive a third input from the user interface, the third input indicating a desired threshold from the plurality of threshold options; and
in at least one of the second mode and the third mode, the control system is configured to:
generate a plurality of countermeasure options;
provide the plurality of countermeasure options to the user interface;
receive a fourth input from the user interface, the fourth input indicating a desired countermeasure from the plurality of countermeasure options; and
provide the signal to the weight transfer system to implement the desired countermeasure.

12. The mower of claim 9, wherein the mower deck includes one or more cutting elements, and wherein the control system is configured to:
determine a position of one or more of the cutting elements;
deactivate the weight transfer system if one or more of the cutting elements are in a lifted position and the weight transfer system is activated; and
prevent the weight transfer system from implementing the countermeasure if one or more of the cutting elements are in the lifted position.

13. The mower of claim 1, further comprising a mower arm coupled between the mower deck and the chassis, wherein the control system is configured to:
determine if the mower arm is raised; and
prevent the weight transfer system from implementing the countermeasure if the mower arm is raised.

14. The mower of claim 1, further comprising a user sensor, wherein the control system is configured to:
activate the weight transfer system when the user sensor senses a first input, and
deactivate the weight transfer system when the user sensor senses a second input.

15. The mower of claim 1, further comprising a user interface, wherein the control system is configured to provide a notification to the user interface when the slope in greater than the threshold.

16. The mower of claim 1, wherein the mower deck includes one or more cutting elements, wherein the threshold is a first threshold, and wherein the control system is configured to prevent the one or more cutting elements from actuating when the slope is greater than a second threshold greater than the first threshold.

17. The mower of claim 1, further comprising a user interface, wherein the control system is configured to:
provide a plurality of threshold options to the user interface; and
receive an input from the user interface, the input indicating a desired threshold from the threshold options.

18. The mower of claim 1, wherein the mower parameter includes a speed of the mower, wherein the threshold is a first threshold, and wherein the control system is configured to:
compare the speed of the mower to a second threshold; and
prevent the weight transfer system from implementing the countermeasure if the speed is greater than the second threshold.

19. A mower comprising:
an electric motor;
one or more front wheels;
one or more rear wheels, where only one of (a) the one or more front wheels or (b) the one or more rear wheels are driven by the electric motor;
a mower deck;
a hydraulic lift system including one or more lift cylinders coupled to the mower deck;
a control system configured to:
acquire a mower parameter, the mower parameter including at least one of (a) a slope of the mower or (b) a location of the mower configured to indicate the slope of the mower;
generate a countermeasure based on a comparison of the mower parameter to a threshold, the countermeasure including activating the hydraulic lift system to provide hydraulic back pressure to the lift cylinders to transfer a percentage of a mass of the mower onto one of (a) the one or more front wheels or (b) the one or more rear wheels driven by the electric motor; and
provide a signal to the hydraulic lift system to implement the countermeasure when the mower parameter is greater than the threshold.

20. A mower comprising:
a chassis;
a tractive element coupled to the chassis;
a mower deck including one or more cutting elements;
a mower arm coupled between the mower deck and the chassis;
a weight transfer system coupled between the mower deck and the chassis;
a sensor configured to facilitate acquiring a mower parameter; and
a control system, when operating the mower in a mode, configured to:
acquire the mower parameter, the mower parameter including at least one of (a) a slope of the mower or (b) a location of the mower configured to indicate the slope of the mower;
generate a countermeasure based on a comparison of the mower parameter to a first threshold, the countermeasure including activating the weight transfer system to transfer at least a portion of a weight of the mower to the tractive element;
determine if the mower arm is raised;
provide a signal to the weight transfer system to implement the countermeasure when the slope of the mower is greater than the first threshold;
prevent the weight transfer system from implementing the countermeasure if the mower arm is raised; and
prevent the one or more cutting elements from actuating when the slope is greater than a second threshold greater than the first threshold.
